(19) United States
(12) Patent Application Publication
(10) Pub. No.: US 2012/0224797 A1
(43) Pub. Date: Sep. 6, 2012

(54) PRE-STRESSED AIR BEARING

(76) Inventors: Wei-Lin Chang, (US); Chang-Cheng Ho, (US)

(21) Appl. No.: 13/041,389

(22) Filed: Mar. 5, 2011

(51) Int. Cl. F16C 32/06

(52) U.S. Cl. 384/106

(57) ABSTRACT

A pre-stressed air bearing includes: a seat member having a seat body and an adjustment section outward extending from a connection end face of the seat body along a geometrical central axis thereof by a predetermined length, an extension end of the adjustment section being slidably connected with a platform, at least one air passage being formed in the seat body, the air passage having at least one air outlet formed on a working end face of the seat body opposite to the connection end face; at least one reception section formed on the working end face in the form of a recess; at least one magnetic member received in the reception section; and a resilient section slidably disposed on the adjustment section between the seat body and the platform for providing a resilient force to keep the seat body spaced from the platform by a buffering gap.

### BACKGROUND OF THE INVENTION

1. Field of the Invention

The present invention relates generally to a platform adjustment member, and more particularly to a pre-stressed air bearing.

2. Description of the Related Art

There is a trend to sophisticate and miniaturize the components of high-tech products. To catch up the trend, a working platform necessitates higher and higher locating precision. In order to achieve high precision, currently, the working platform is generally directly driven by a linear motor to enhance the processing precision and quickly locate the working platform. However, when the linear motor drives the working platform to move, the friction between the working platform and a guide rail connection face will interfere with the operation of the working platform to cause deterioration of stability and precision.

FIG. 1 shows a conventional air bearing 1. The air bearing 1 is disposed on a working platform 2, which is directly driven by a linear motor. An air gap 4 exists between the air bearing 1 and a guide rail connection face 3, whereby the air bearing 1 is suspended above the air gap 4. In this case, the working platform 2 is not in direct contact with the guide rail connection face 3 so that the friction between the working platform 2 and the guide rail connection face 3 is effectively reduced. Moreover, since the air bearing 1 is not in direct contact with the guide rail connection face 3, no lubrication is needed and the surface is not subject to wearing. Therefore, the lifetime of the working platform 2 can be prolonged and the vibration and noise made in operation can be minimized. Also, the stability in use of the working platform 2 can be greatly enhanced.

The air bearing has many advantages as aforesaid. However, it is necessary to stabilize the air gap to increase the rigidity thereof. Therefore, the air bearing must be combined with a pre-stressed measure to control the air gap. The air gap must be adjusted in a direction normal to the air bearing to achieve an optimal value. Currently, the air gap is controlled in such a manner that an external magnet is used to provide the pre-stress. The external magnet is combined with a ball joint air bearing, which can be rotationally adjusted and rectified. The above measure has the following shortcomings: First, it is necessary to provide an additional space for receiving the magnet to provide the pre-stress. Therefore, the manufacturing process is complicated. Second, when the magnet provides the pre-stress for the air bearing, a torque is formed to deteriorate the stability of the entire air bearing.

### SUMMARY OF THE INVENTION

It is therefore a primary object of the present invention to provide a pre-stressed air bearing, which directly provides a pre-stress without forming any torque.

It is a further object of the present invention to provide the above pre-stressed air bearing, which necessitates no additional space for receiving the magnet to provide the pre-stress. Therefore, the manufacturing process is simplified.

To achieve the above and other objects, the pre-stressed air bearing of the present invention is disposable on a platform. The pre-stressed air bearing includes: a seat member having a seat body and an adjustment section, the adjustment section outward extending from a connection end face on one side of the seat body along a geometrical central axis of the seat body by a predetermined length, an extension end of the adjustment section being slidably connected with the platform, at least one air passage being formed in the seat body, the air passage having at least one air outlet formed on a working end face of the seat body opposite to the connection end face; at least one reception section formed on the working end face of the seat body in the form of a recess; at least one magnetic member received in the reception section; and a resilient section slidably disposed on the adjustment section and positioned between the seat body and the platform. The resilient section serves to provide a resilient force to keep the seat body spaced from the platform by a buffering gap.

The present invention can be best understood through the following description and accompanying drawings, wherein:

### BRIEF DESCRIPTION OF THE DRAWINGS

FIG. 1 is a sectional view of a conventional air bearing, showing that the air bearing is disposed on a working platform;

FIG. 2 is a top view of a preferred embodiment of the present invention;

FIG. 3 is a sectional view taken along line 3-3 of FIG. 2; and

FIG. 4 is a sectional view according to FIG. 3, showing the use of the preferred embodiment of the present invention.

### DETAILED DESCRIPTION OF THE PREFERRED EMBODIMENTS

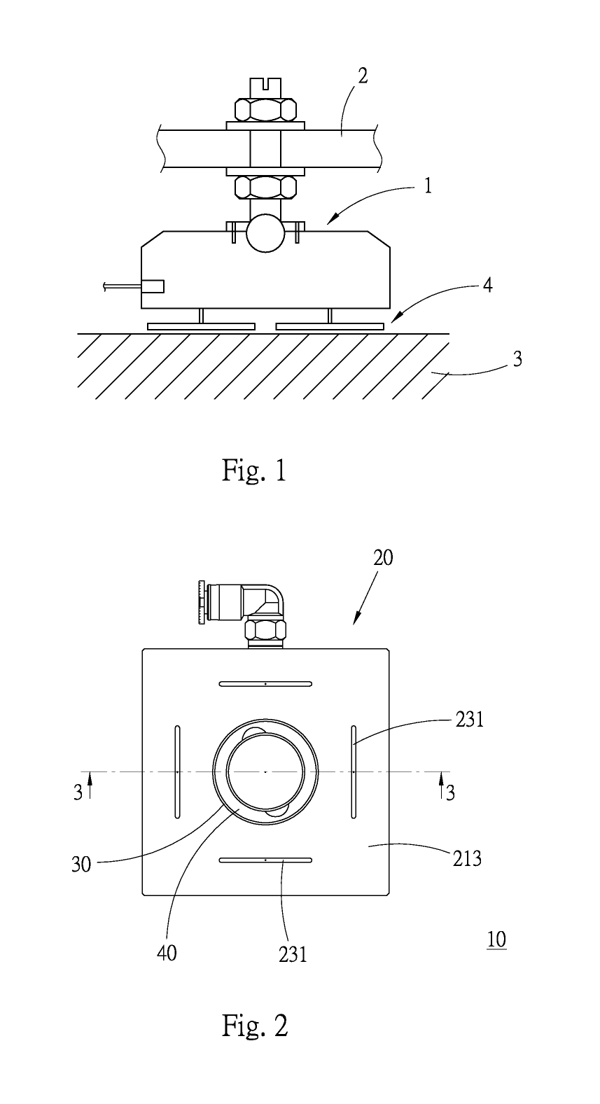

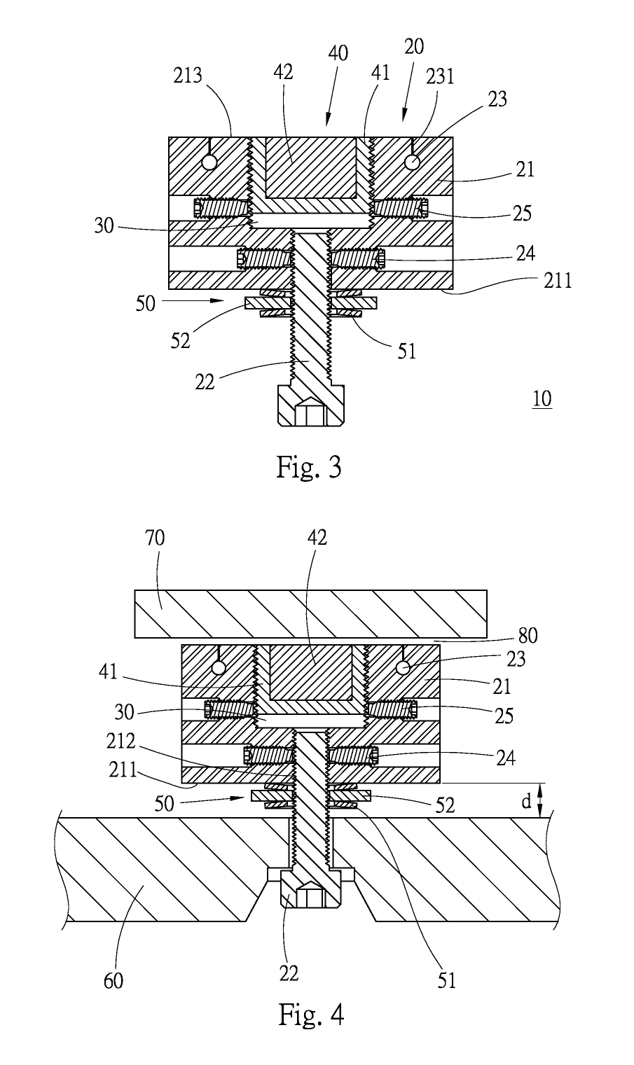

Please refer to FIGS. 2 and 3. According to a preferred embodiment, the pre-stressed air bearing 10 of the present invention is disposed on a platform (not shown), including a seat member 20, a reception section 30, a magnetic member 40 and a resilient section 50.

The seat member 20 has a rectangular seat body 21 and an adjustment section 22 formed of a threaded rod. The threaded rod has an axis coinciding with a geometrical central axis of the seat body 21. A first end of the threaded rod is screwed in a threaded hole 212 formed on a connection end face 211 on a bottom side of the seat body 21. A second end of the threaded rod outward extends from the connection end face 211 of the seat body 21 by a predetermined length. An extension end of the threaded rod is slidably connected with the platform. At least one air passage 23 is formed in the seat body 21. The air passage 23 has at least one air outlet 231 formed on a working end face 213 of the seat body 21 opposite to the connection end face 211.

The reception section 30 is a threaded hole formed on the working end face 213 of the seat body 21 in the form of a recess. The reception section 30 is coaxially downward recessed from the working end face 213 along the geometrical central axis of the seat body 21 by a certain depth.

The magnetic member 40 has a cylindrical barrel 41 with a top opening. An outer circumference of the cylindrical barrel 41 is formed with a thread, which is coaxially screwed in the reception section 30. A magnet 42 is inlaid in an interior of the cylindrical barrel 41.

The resilient section 50 is slidably disposed on the adjustment section 22 and positioned between the seat body 21 and the platform. The resilient section 50 includes two disc-shaped springs 51 coaxially slidably fitted around the adjustment section 22 opposite to each other. The resilient section 50 further includes a spacer 52 with a certain thickness. The spacer 52 is slidably disposed on the adjustment section 22 and positioned between the disc-shaped springs 51. Accordingly, the resilient section 50 can provide resilient force to keep the seat body 21 spaced from the platform by a buffering gap.

To speak more specifically, the seat member 20 further includes at least one first locating section 24 and at least one second locating section 25.

The first locating sections 24 are two set screws with predetermined length. The first locating section 24 extends into the seat body 21 with the axis of the first locating section 24 normal to the geometrical central axis of the seat body 21. One end of the first locating section 24 abuts against the threaded rod body of the adjustment section 22 for locating the adjustment section 22 in the seat body 21.

The second locating sections 25 are two set screws with predetermined length. The second locating section 25 extends into the seat body 21 with the axis of the second locating section 25 normal to the geometrical central axis of the seat body 21. One end of the second locating section 24 abuts against the outer circumference of the cylindrical barrel 41 of the magnetic member 40 for locating the magnetic member 40 in the reception section 30.

According to the above arrangement, the pre-stressed air bearing 10 of the present invention is applicable to various high-precision platforms. Please refer to FIG. 4. The second end of the adjustment section 20 is slidably connected with a guide rail platform 60. An operation platform 70 is linearly movably disposed above the seat member 30 opposite to the guide rail platform 60. The air is continuously released from the air outlet 231, whereby an air gap 80 exists between the seat member 20 and the operation platform 70 during the operation of the operation platform 70. In this case, the operation platform 70 is movably suspended above the air gap 80.

The magnetic member 40 serves to provide a magnetic force as a pre-stress against the buoyancy between the seat member 20 and the operation platform 70 for controlling the air gap 80. Moreover, the resilient section 50 serves to provide a resilient force to adjust and rectify the degree of freedom of rotation of the air bearing so as to keep stability of the operation platform 70 in movement. In addition, a user can change the position of the magnetic member 40 according to different requirements for controlling the pre-stress. For example, the depth or position of the magnetic member 40 in the reception section 30 can be adjusted. Alternatively, the adjustment section 22 can be rotated to change the position of the seat body 21. By means of changing the depth by which the adjustment section 22 is screwed in the seat body 21, the buffering gap d can be changed so as to adjust the resilient buffering range provided by the resilient section 50.

The pre-stressed air bearing 10 of the present invention is mainly characterized in that the magnetic member 40 is directly mounted in the seat member 20 to provide a controllable pre-stress. By means of the resilient section 50, the degree of freedom of rotation of the air bearing can be adjusted and rectified. Accordingly, the pre-stressed air bearing 10 of the present invention has the following advantages:

1. It is unnecessary to provide a space outside the air bearing to receive the magnetic member for providing the pre-stress.

2. The magnetic member is directly disposed in the seat body so that the manufacturing process is simplified.

3. The air bearing directly contains the magnetic member therein so that the pre-stress provided by the magnetic member is normal to the horizontal plane without forming any torque.

4. A user can directly adjust the position where the adjustment section is screwed in the seat body as necessary or adjust the position where the magnetic member is received in the reception section so as to control the pre-stress.

Also, it should be noted that in the above embodiment of the pre-stressed air bearing of the present invention, the adjustment section is slidably connected with the guide rail platform. Alternatively, in another embodiment, the adjustment section can be slidably connected with the operation platform. In this case, the air gap will exist between the guide rail platform and the seat member. This embodiment can also achieve the effect of the present invention.

The above embodiments are only used to illustrate the present invention, not intended to limit the scope thereof. Many modifications of the above embodiments can be made without departing from the spirit of the present invention.

What is claimed is:

1. A pre-stressed air bearing disposable on a platform, the pre-stressed air bearing comprising:
a seat member having a seat body and an adjustment section, the adjustment section outward extending from a connection end face on one side of the seat body along a geometrical central axis of the seat body by a predetermined length, an extension end of the adjustment section being slidably connected with the platform, at least one air passage being formed in the seat body, the air passage having at least one air outlet formed on a working end face of the seat body opposite to the connection end face;
at least one reception section formed on the working end face of the seat body in the form of a recess;
at least one magnetic member received in the reception section; and
a resilient section slidably disposed on the adjustment section and positioned between the seat body and the platform, the resilient section serving to provide a resilient force to keep the seat body spaced from the platform by a buffering gap.

2. The pre-stressed air bearing as claimed in claim 1, wherein the adjustment section is a threaded rod, one end of the threaded rod being screwed with the seat body.

3. The pre-stressed air bearing as claimed in claim 1, wherein the reception section has a geometrical central axis coinciding with a geometrical central axis of the seat body.

4. The pre-stressed air bearing as claimed in claim 2, wherein the seat member further includes at least one first locating section for locating the adjustment section in the seat body and at least one second locating section for locating the magnetic member in the reception section.

5. The pre-stressed air bearing as claimed in claim 4, wherein the first locating section is a set screw.

6. The pre-stressed air bearing as claimed in claim 4, wherein the second locating section is a set screw.

7. The pre-stressed air bearing as claimed in claim 1, wherein the resilient section is a disc-shaped spring.

8. The pre-stressed air bearing as claimed in claim 1, wherein the reception section is a threaded hole in which the magnetic member is screwed.

9. The pre-stressed air bearing as claimed in claim 8, wherein the magnetic member includes a barrel screwed in the reception section and a magnet inlaid in an interior of the barrel.
